(19) United States
(12) Patent Application Publication
(10) Pub. No.: US 2023/0308886 A1
(43) Pub. Date: Sep. 28, 2023

(54) METHOD AND APPARATUS FOR CONFIGURING SENSING IN CELLULAR SYSTEMS

(71) Applicant: Samsung Electronics Co., Ltd., Suwon-si (KR)

(72) Inventors: Jeongho Jeon, San Jose, CA (US); Caleb K. Lo, San Jose, CA (US); Pranav Madadi, Sunnyvale, CA (US); Joonyoung Cho, Portland, OR (US); Jianzhong Zhang, Dallas, TX (US)

(21) Appl. No.: 18/163,225

(22) Filed: Feb. 1, 2023

Related U.S. Application Data
(60) Provisional application No. 63/324,222, filed on Mar. 28, 2022.

(51) Int. Cl. H04W 16/14; H04W 72/0453; H04W 74/08

(52) U.S. Cl. CPC H04W 16/14; H04W 72/0453; H04W 74/0808

(57) ABSTRACT

Joint configuration of cellular communications and radar sensing involves reporting of UE sensing capability information including coexistence of sensing function with cellular communication function within the UE, UE sensing hardware capability, and capability related to UE sensing parameters or modes. A sensing configuration request by the UE includes sensing application type, sensing range, and sensing periodicity. A sensing configuration by the network includes sensing transmission power, power control parameters, waveform, and sensing resources and periodicity. A sensing procedure is performed based on the sensing configuration.

### CROSS-REFERENCE TO RELATED APPLICATION AND CLAIM OF PRIORITY

This application claims priority under 35 U.S.C. § 119(e) to U.S. Provisional Patent Application No. 63/324,222 filed Mar. 28, 2022. The content of the above-identified patent document(s) is incorporated herein by reference.

### TECHNICAL FIELD

The present disclosure relates generally to joint configuration of cellular communication and radar sensing, and more specifically to joint configuration for both monostatic and bi-static radar sensing in a cellular communications system.

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 giga-Hertz (GHz) or 60 GHz bands, so as to accomplish higher data rates or in lower frequency bands, such as 1-2 GHz, 3.5 GHz, or up to 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G and/or 6G systems and frequency bands associated therewith is for reference as certain embodiments of the present disclosure may be implemented in 5G systems. However, the present disclosure is not limited to 5G and/or 6G systems or the frequency bands associated therewith, and embodiments of the present disclosure may be utilized in connection with any frequency band. For example, aspects of the present disclosure may also be applied to deployment of 5G communication systems as well as 6G or even later releases which may use terahertz (THz) bands.

### SUMMARY

Joint configuration of cellular communications and radar sensing involves reporting of UE sensing capability information including coexistence of sensing function with cellular communication function within the UE, UE sensing hardware capability, and capability related to UE sensing parameters or modes. A sensing configuration request by the UE includes sensing application type, sensing range, and sensing periodicity. A sensing configuration by the network includes sensing transmission power, power control parameters, waveform, and sensing resources and periodicity. A sensing procedure is performed based on the sensing configuration.

In a first embodiment, a method performed by a user equipment (UE) includes transmitting, to the base station (BS), UE sensing capability information, the UE sensing capability information including coexistence of sensing function with cellular communication function within the UE, UE sensing hardware capability, and capability related to UE sensing parameters or modes. The method also includes transmitting, to the BS, a sensing configuration request, the sensing configuration request including sensing application type, sensing range, and sensing periodicity or including an index from a plurality of predefined sensing modes. The method further includes receiving, from the BS, a sensing configuration, the sensing configuration including sensing transmission power, power control related parameters, waveform, and sensing resources and periodicity. The method still further includes performing, based on the sensing configuration, a sensing procedure.

In a second embodiment, a user equipment (UE) includes a transceiver configured to transmit, to the base station (BS), UE sensing capability information, the UE sensing capability information including coexistence of sensing function with cellular communication function within the UE, UE sensing hardware capability, and capability related to UE sensing parameters or modes. The transceiver is also configured to transmit, to the BS, a sensing configuration request, the sensing configuration request including sensing application type, sensing range, and sensing periodicity or including an index from a plurality of predefined sensing modes. The transceiver is further configured to receive, from the BS, a sensing configuration, the sensing configuration including sensing transmission power, power control related parameters, waveform, and sensing resources and periodicity. The UE also includes a processor coupled to the transceiver and configured to perform, based on the sensing configuration, a sensing procedure.

In a third embodiment, a base station includes a processor configured to determine a sensing configuration for a sensing procedure. The base station also includes a transceiver coupled to the processor and configured to receive, from a user equipment (UE), UE sensing capability information, the UE sensing capability information including coexistence of sensing function with cellular communication function within the UE, UE sensing hardware capability, and capability related to UE sensing parameters or modes. The transceiver is also configured to receive, from the UE, a sensing configuration request, the sensing configuration request including sensing application type, sensing range, and sensing periodicity or including an index from a plurality of predefined sensing modes. The transceiver is further configured to transmit, to the UE, a sensing configuration, the sensing configuration including sensing transmission power, power control related parameters, waveform, and sensing resources and periodicity.

In any of the preceding embodiments, the UE sensing capability information may comprise: whether the UE is capable of canceling a cellular communication signal transmitted by the UE from a sensing signal received at the UE; whether the UE is capable of canceling a sensing signal transmitted by the UE from a cellular communication signal received at the UE; and whether the UE is capable of successive interference cancellation for simultaneous reception of cellular communication and sensing signals.

In any of the preceding embodiments, the UE sensing capability information may comprise: capability to control a sensing function of the UE by a cellular modem within the UE; whether antennas for cellular communication are shared for sensing; whether simultaneous operation of sensing and communication is possible; whether antennas for sensing transmission and sensing reception are shared; whether monostatic, bistatic, or both monostatic and bistatic sensing are supported; and supported types of sensing waveforms.

In any of the preceding embodiments, the UE sensing capability information may comprise: a maximum transmission power capability for sensing; a maximum supported sensing bandwidth; an indication of whether aggregating multiple carriers for transmitting and receiving sensing signals is supported, and the supported number of carriers for aggregation; a list of bands supported for sensing; and an indication of whether in-band sensing is supported.

In any of the preceding embodiments, the sensing configuration request may further include: a desired transmission power or range; a desired sensing resolution or bandwidth; whether a continuous or periodic sensing is employed; whether directional sensing is employed; a desired number of beams and beam pattern, if directional sensing is employed; and sensing duration.

In any of the preceding embodiments, the sensing configuration request may comprise one of a plurality of predefined sensing modes, each of the sensing modes associated with a transmission power, a bandwidth, range, a periodicity, a resolution, whether directional sensing is used, a sensing duration, or sensing application type.

In any of the preceding embodiments, the sensing configuration received from the BS may further include one of a number of beams allowed for sensing sweeping, a beamforming/antenna gain allowed, or a 3 decibels (dB) beam width.

In any of the preceding embodiments, the sensing configuration received from the BS may further include parameters related to channel access mechanism if unlicensed spectrum is configured, the parameters including listen-before-talk (LBT) type, contention window size, energy and/or signal detection threshold, or allowance of channel occupancy time (COT) sharing.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an exemplary networked system utilizing reference signal temporal density configuration according to various embodiments of this disclosure;

FIG. 2 illustrates an exemplary base station (BS) utilizing reference signal temporal density configuration according to various embodiments of this disclosure;

FIG. 3 illustrates an exemplary electronic device for communicating in the networked computing system utilizing reference signal temporal density configuration according to various embodiments of this disclosure;

FIG. 4 illustrates a high level diagram of a monostatic radar according to various embodiments of this disclosure;

FIGS. 5A and 5B illustrate high level diagrams of a bi-static radar according to various embodiments of this disclosure;

FIG. 6 illustrates a high level diagram of a JCS implementation according to various embodiments of this disclosure;

FIG. 7 illustrates a high level diagram of JCS signal flow diagram according to various embodiments of this disclosure;

FIG. 8 illustrates a high level flowchart for UE operation of sensing configuration according to various embodiments of this disclosure;

FIG. 9 illustrates a high level flowchart for NW operation of sensing configuration according to various embodiments of this disclosure; and

FIG. 10 illustrates an example timing diagram for monostatic sensing according to various embodiments of this disclosure.

### DETAILED DESCRIPTION

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

### REFERENCES

[1] 3GPP TS 38.211 Rel-16 v16.4.0, “NR; Physical channels and modulation,” December 2020.
[2] 3GPP TS 38.212 Rel-16 v16.4.0, “NR; Multiplexing and channel coding,” December 2020.
[3] 3GPP TS 38.213 Rel-16 v16.4.0, “NR; Physical layer procedures for control,” December 2020.
[4] 3GPP TS 38.214 Rel-16 v16.4.0, “NR; Physical layer procedures for data,” December 2020.
[5] 3GPP TS 38.321 Rel-16 v16.3.0, “NR; Medium Access Control (MAC) protocol specification,” December 2020.
[6] 3GPP TS 38.331 Rel-16 v16.3.0, “NR; Radio Resource Control (RRC) protocol specification,” December 2020.
[7] 3GPP TS 38.300 Rel-16 v16.4.0, “NR; NR and NG-RAN Overall Description; Stage 2,” December 2020.

The above-identified references are incorporated herein by reference.

### Abbreviations

3GPP Third generation partnership project
ACK Acknowledgement
AP Antenna port
BCCH Broadcast control channel
BCH Broadcast channel
BD Blind decoding
BFR Beam failure recovery
BI Back-off indicator
BW Bandwidth
BLER Block error ratio
BL/CE Bandwidth limited, coverage enhanced
BWP Bandwidth Part
CA Carrier aggregation
CB Contention based
CBG Code block group
CBRA Contention based random access
CBS PUR Contention based shared PUR
CCE Control Channel Element
CD-SSB Cell-defining SSB
CE Coverage enhancement
CFRA Contention free random access
CFS PUR Contention free shared PUR
CG Configured grant
CGI Cell global identifier
CI Cancellation indication
CORESET Control Resource Set
CP Cyclic prefix
C-RNTI Cell RNTI
CRB Common resource block
CR-ID Contention resolution identity
CRC Cyclic Redundancy Check
CSI Channel State Information
CSI-RS Channel State Information Reference Signal
CS-G-RNRI Configured scheduling group RNTI
CS-RNTI Configured scheduling RNTI
CSS Common search space
DAI Downlink assignment index
DCI Downlink Control Information
DFI Downlink Feedback Information
DL Downlink
DMRS Demodulation Reference Signal
DTE Downlink transmission entity
EIRP Effective isotropic radiated power
eMTC enhanced machine type communication
EPRE Energy per resource element
FDD Frequency Division Duplexing
FDM Frequency division multiplexing
FDRA Frequency domain resource allocation
FR1 Frequency range 1
FR2 Frequency range 2
gNB gNodeB
GPS Global positioning system
HARQ Hybrid automatic repeat request
HARQ-ACK Hybrid automatic repeat request acknowledgement
HARQ-NACK Hybrid automatic repeat request negative acknowledgement
HPN HARQ process number
ID Identity
IE Information element
IIoT Industrial internet of things
IoT Internet of Things
JCS Joint Communication and Sensing
KPI Key performance indicator
LBT Listen before talk
LNA Low-noise amplifier
LRR Link recovery request
LSB Least significant bit
LTE Long Term Evolution
MAC Medium access control
MAC-CE MAC control element
MCG Master cell group
MCS Modulation and coding scheme
MIB Master Information Block
MIMO Multiple input multiple output
MPE maximum permissible exposure
MTC Machine type communication
mMTC massive machine type communication
MSB Most significant bit
NACK Negative acknowledgment
NDI New data indicator
NPN Non-public network
NR New Radio
NR-L NR Light/NR Lite
NR-U NR unlicensed
NTN Non-terrestrial network
NW Network
OSI Other system information
PA Power amplifier
PI Preemption indication
PBCH Physical broadcast channel
PCell Primary cell
PRACH Physical Random Access Channel
PDCCH Physical Downlink Control Channel
PDSCH Physical Downlink Shared Channel
PUCCH Physical Uplink Control Channel
PUSCH Physical Uplink Shared Channel
PMI Precoder matrix indicator
P-MPR Power Management Maximum Power Reduction
PO PUSCH occasion
PSCell Primary secondary cell
PSS Primary synchronization signal
P-RNTI Paging RNTI
PRG Precoding resource block group
PRS Positioning reference signal
PTRS Phase tracking reference signal
PUR Pre-configured uplink resource
QCL Quasi co-located/Quasi co-location
RA Random access
RACH Random access channel
RAPID Random access preamble identity
RAR Random access response
RA-RNTI Random access RNTI
RAN Radio Access Network
RAT Radio access technology
RB Resource Block
RBG Resource Block group
RF Radio Frequency
RLF Radio link failure
RLM Radio link monitoring
RMSI Remaining minimum system information
RNTI Radio Network Temporary Identifier
RO RACH occasion
RRC Radio Resource Control
RS Reference Signal
RSRP Reference signal received power
RV Redundancy version
Rx Receive/Receiving
SAR Specific absorption rate
SCG Secondary cell group
SFI Slot format indication
SFN System frame number
SI System Information
SIC Successive Interference Cancellation
SI-RNTI System Information RNTI
SIB System Information Block
SINR Signal to Interference and Noise Ratio
SCS Sub-carrier spacing
SMPTx Simultaneous multi-panel transmission
SMPTRx Simultaneous multi-panel transmission and reception
SpCell Special cell
SPS Semi-persistent scheduling
SR Scheduling Request
SRI SRS resource indicator
SRS Sounding reference signal
SS Synchronization signal
SSB SS/PBCH block
SSS Secondary synchronization signal
STxMP Simultaneous transmission by multiple panels
STRxMP Simultaneous transmission and reception by multiple panels
TA Timing advance
TB Transport Block
TBS Transport Block size
TCI Transmission Configuration Indication
TC-RNTI Temporary cell RNTI
TDD Time Division Duplexing
TDM Time division multiplexing
TDRA Time domain resource allocation
TPC Transmit Power Control
TRP Total radiated power
Tx Transmit/Transmitting
UCI Uplink Control Information
UE User Equipment
UL Uplink
UL-SCH Uplink shared channel
URLLC Ultra reliable and low latency communication
UTE Uplink transmission entity
V2X Vehicle to anything
VoIP Voice over Internet Protocol (IP)
XR eXtended reality k

The present disclosure relates to beyond 5G or 6G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 6G, and so on), IEEE standards (such as 802.11/15/16), and so forth.

This disclosure pertains joint communication and radar sensing, wherein a UE is able to perform downlink/uplink/sidelink communication and also perform radar sensing by “sensing”/detecting environmental objects and their physical characteristics such as location/range, velocity/speed, elevation, angle, and so on. Radar sensing is achieved by sending a suitable sounding waveform and receiving and analyzing reflections or echoes of the sounding waveform. Such radar sensing operation can be used for applications and use-case such as proximity sensing, liveness detection, gesture control, face recognition, room/environment sensing, motion/presence detection, depth sensing, and so on, for various UE form factors. For some larger UE form factors, such as (driver-less) vehicles, trains, drones and so on, radar sensing can be additionally used for speed/cruise control, lane/elevation change, rear/blind spot view, parking assistance, and so on. Such radar sensing operation can be performed in various frequency bands, including millimeter wave (mmWave)/FR2 bands. In addition, with terra-Hertz (THz) spectrum, ultra-high resolution sensing, such as sub-cm level resolution, and sensitive Doppler detection, such as micro-Doppler detection, can be achieved with very large bandwidth allocation, for example, on the order of several giga-Hertz (GHz) or more.

Current implementations can support individual operation of communication and sensing, where the UE is equipped with separate modules (in terms of baseband processing units and/or RF chain and antenna arrays) for communication procedures and radar procedures. The separate communication and sensing architectures requires repetitive implementation that increases UE complexity. In addition, since the two modules are designed separately, there is little/no coordination between them, so time/frequency/sequence/spatial resources are not efficiently used by the two modules, which in some cases can even lead to (self-)interference between the two modules of a same UE. In addition, the radar sensing operation of the UE can be based on pure implementation based methods and without any unified standards support, which can cause (significant) inter-UE issues, or may not be fully compatible with cellular systems. Furthermore, separate design of the two modules makes it difficult to use measurement or information acquired by one module to assist the other module. For example, the communication module may be unaware of a potential beam blockage due to a nearby object, although the sensing module may have already detected the object.

There is a need to develop a unified standard for support of joint communication and sensing to reduce the UE implementation complexity and enable coexistence of the two modules. There is another need to ensure time/frequency/sequence/spatial resources are efficiently used across communication and sensing modules of a same UE, as well as among different UEs performing these two operations, to reduce/avoid (self-) interference. There is a further need to design the two operations in such a way to provide assistance to each other by exchanging measurement results and acquired information, so that both procedures can operate more robustly and effectively.

The present disclosure provides designs for the support of joint communication and radar sensing. In particular, this disclosure is regarding a framework to operate sensing functions in wireless communication systems including requesting and configuring sensing operations in wireless communication systems.

Embodiments of the disclosure for supporting joint communication and radar sensing in wireless communication systems are summarized in the following and are fully elaborated further below.
UE-NW procedure for requesting and configuring sensing operations in wireless communication systems.
IEs for UE sensing capability indication
IEs for UE sensing configuration request
IEs for NW sensing configuration message

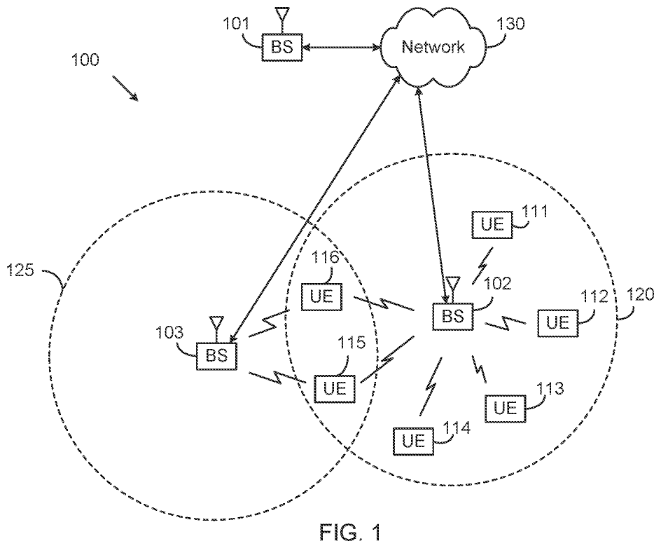

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an exemplary networked system utilizing reference signal temporal density configuration according to various embodiments of this disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

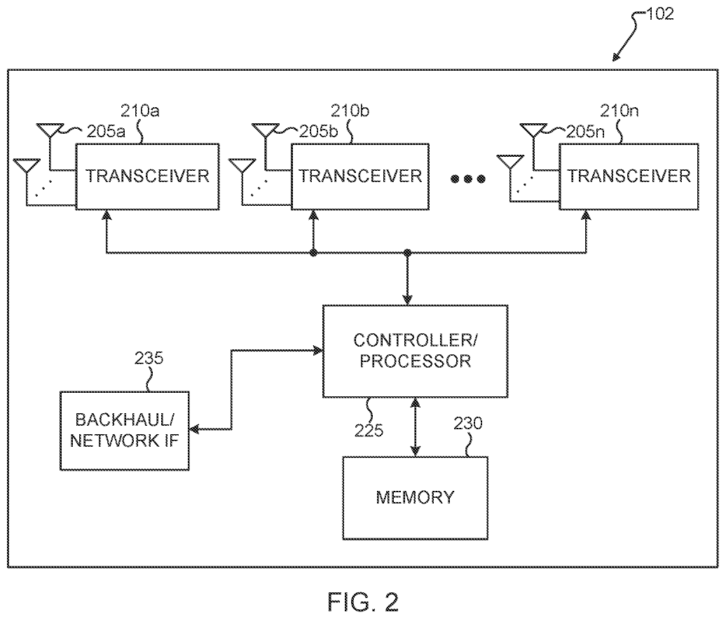

FIG. 2 illustrates an exemplary base station (BS) utilizing reference signal temporal density configuration according to various embodiments of this disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

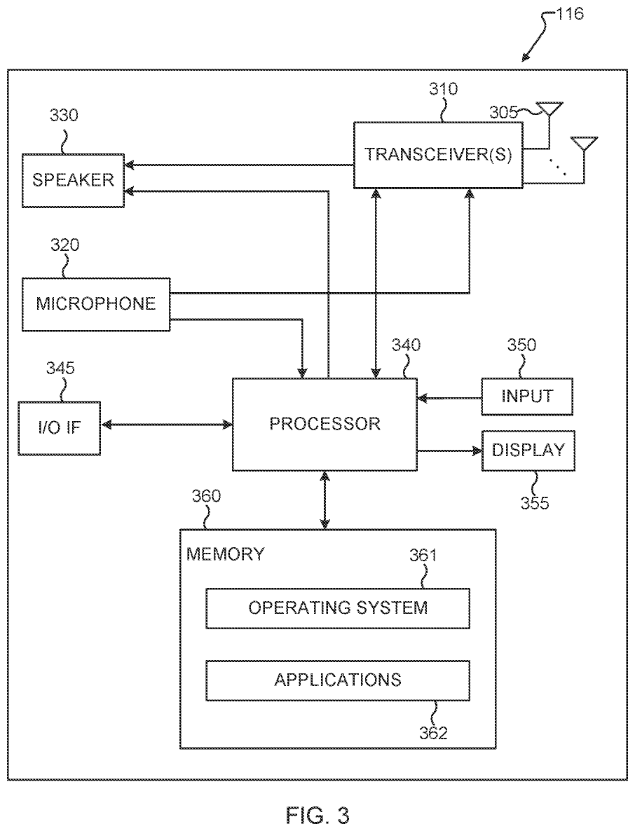

FIG. 3 illustrates an exemplary electronic device for communicating in the networked computing system utilizing reference signal temporal density configuration according to various embodiments of this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

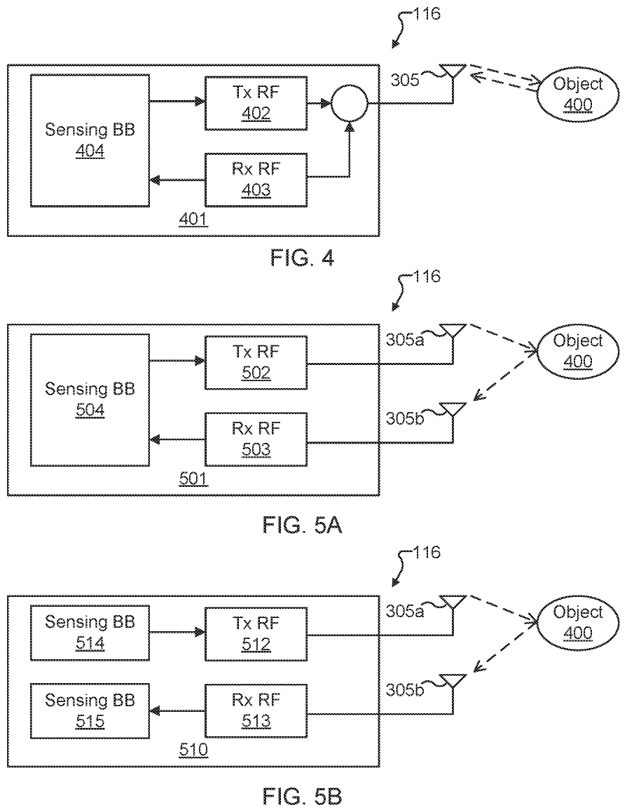

FIG. 4 illustrates a high level diagram of a monostatic radar according to various embodiments of this disclosure. The embodiment of FIG. 4 is for illustration only. Other embodiments of the system 401 could be used without departing from the scope of this disclosure.

FIG. 4 illustrates a monostatic radar system in which the transmission of radar waveform and the reception of reflected waveform alternates and performed within a device 116. Monostatic radar system 401 includes transmit RF processing 402 and receive RF processing 403 coupled to the same antenna 305, and respectively receiving output from and providing input to a single baseband (BB) processing circuit 404. Signals provided by transmit RF processing 402 are transmitted using the antenna 305, reflect off the object 400 and are received by antenna 305, and are filtered and otherwise pre-processed by receive RF processing 403 for use by sensing baseband processing circuit 404 in determining distance, velocity, acceleration, and/or direction of the object 400. Monostatic radar is suitable for short pulse sensing waveform. To avoid self-interference, the radio needs to turn around from transmission to reception before the reflected signal arrives.

FIGS. 5A and 5B illustrate high level diagrams of a bi-static radar according to various embodiments of this disclosure. The embodiments of FIGS. 5A-5B are for illustration only. Other embodiments of the systems 501, 510 could be used without departing from the scope of this disclosure.

FIGS. 5A and 5B illustrate a bi-static radar system in which the transmission of radar waveform and the reception of reflected waveform can be performed concurrently within a device 116. In each of FIGS. 5A and 5B, radar system 501, 510 includes respective transmit RF processing 502, 512 and respective receive RF processing 503, 513 coupled to different antenna 305a, 305b. In both FIG. 5A and FIG. 5B, signals provided by transmit RF processing 502, 512 are transmitted using one antenna 305a, reflect off the object 400 and are received by another antenna 305b, and are filtered and otherwise pre-processed by receive RF processing 503, 513. However, transmit RF processing 502 and receive RF processing 503 in FIG. 5A still respectively receive output from and provide input to a single baseband processing circuit 504. By contrast, transmit RF processing 512 receives output from one baseband processing circuit 514 in FIG. 5B, and receive RF processing 513 provides input to a separate baseband processing circuit 515.

Bi-static radar is suitable for continuous transmission of sensing waveform. Both transmission and reception modules can be placed within a device as shown in FIGS. 5A and 5B. In these cases, a separation between transmission and reception antennas is desired. In other embodiments of a bi-static radar system, transmission and reception modules are placed in different devices. A separation between transmission and reception antennas is naturally achieved.

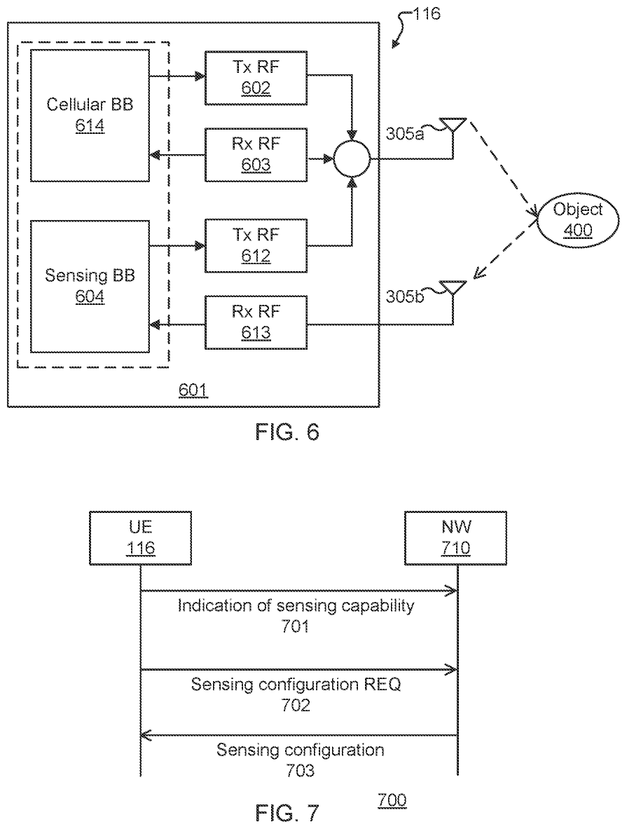

FIG. 6 illustrates a high level diagram of a JCS implementation according to various embodiments of this disclosure. The embodiment of FIG. 6 is for illustration only. Other embodiments of the system 601 could be used without departing from the scope of this disclosure.

FIG. 6 illustrates a possible JCS UE implementation for UEs having cellular communication modules. JCS system 601 includes transmit RF processing 602 and receive RF processing 603 coupled to one antenna 305a, and respectively receiving output from and providing input to a cellular baseband processing circuit 614. JCS system 601 also includes transmit RF processing 612 coupled to the first antenna 305a, and receive RF processing 603 coupled to a second antenna 305b. Transmit RF processing 612 and receive RF processing 603 respectively receive output from and provide input to a single sensing baseband processing circuit 604.

The cellular baseband processing circuit 614 and the sensing baseband processing circuit 604 may be discrete modules communicating with each other, or may be (as depicted) logically separate but integrated into a single module. In this example, the transmission of sensing waveform and the reception of reflected sensing waveform can be concurrent while transmission/reception for communication are switched off, enabling bi-static radar operation. Also, concurrent transmission for communication and reception for sensing waveform are possible. In that case, the sensing could be monostatic (the UE both transmits and receives sensing waveforms) or bi-static (another UE or device transmits the sensing waveform). Concurrent reception for communication and reception for sensing are also possible. SIC may be applied to remove the interference from sensing signal for the reception of communication signal or vice versa.

FIG. 7 illustrates a high level diagram of JCS signal flow diagram according to various embodiments of this disclosure. The embodiment of FIG. 7 is for illustration only. Other embodiments of signaling could be used without departing from the scope of this disclosure.

FIG. 7 is an example procedure for UE 116 and NW 710 (e.g., BS 102) to exchange messages for sensing configuration. In the first step 701, a UE 116 sends UE Capability Information (e.g., RRC message) to NW 710, informing the NW 710 of the UE's JCS capability including hardware (HW) capability, SIC capability, etc. In the second step 702, the UE 116 sends a sensing configuration request message including sensing application type, range, and sensing periodicity, etc. In the third step 703, the NW 710 configures sensing operations to UE 116 including waveform, resource, sensing transmission power, periodicity, etc.

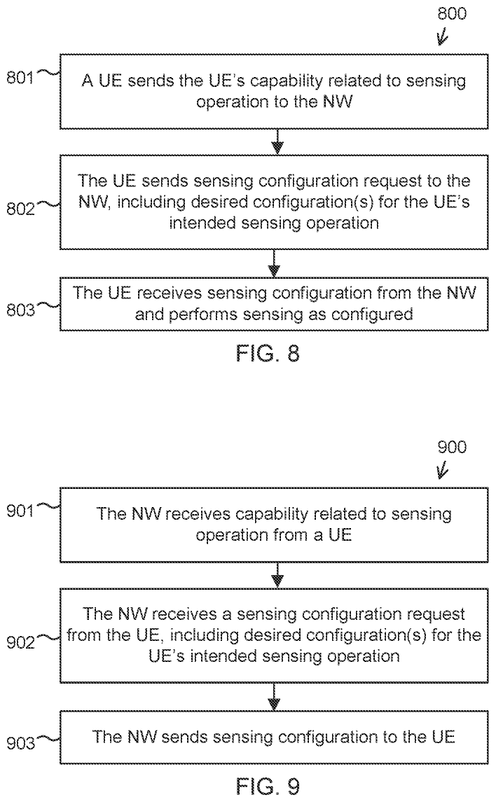

FIG. 8 illustrates a high level flowchart for UE operation of sensing configuration according to various embodiments of this disclosure. The embodiment of FIG. 8 is for illustration only. Other embodiments of the process 800 could be used without departing from the scope of this disclosure.

FIG. 8 is an example of a method 800 for sensing configuration from a UE perspective consistent with FIG. 7. At step 801, the UE sends the UE's capability (e.g., in an RRC message) related to sensing operations to the NW, informing the NW of the UE's JCS capability including hardware capability, SIC capability, etc. At step 802, the UE sends a sensing configuration request message including desired configuration(s) (sensing application type, range, and sensing periodicity, etc.). At step 803, the UE receives sensing configurations from the NW, and then performs sensing as configured.

FIG. 9 illustrates a high level flowchart for NW operation of sensing configuration according to various embodiments of this disclosure. The embodiment of FIG. 9 is for illustration only. Other embodiments of the process 900 could be used without departing from the scope of this disclosure.

FIG. 9 is an example of a method 900 for sensing configuration from a NW perspective, consistent with FIG. 7. At step 901, the NW receives the UE's capability (e.g., in an RRC message) related to sensing operations. At step 902, the NW receives a sensing configuration request message including desired configuration(s) (sensing application type, range, and sensing periodicity, etc.) for the UE's intended sensing operation. At step 903, the NW sends sensing configurations from the NW, and then performs sensing as configured.

In one embodiment, the UE can send its sensing capability to NW. TABLE 1 is an example list of possible information elements (IEs) for UE sensing capability indication to NW:

TABLE 1
Possible IEs for UE sensing capability indication msg

| | |
|---|---|
| BB coordination | Coordination between cellular and sensing modem |
| Sensing power | Max Tx power for sensing |
| class | |
| Sensing BW, | Max supported sensing BW; list of supported bands |
| supported bands, | for sensing; indication on whether in-band sensing is |
| in-band sensing | supported or not |
| capability, etc. | |
| RF/Antenna | Shared or separate between cellular and sensing |
| | Shared or separate between sensing Tx and sensing |
| | Rx (monostatic vs. bistatic) |
| Self-interference | Cancellation of cellular Tx signal from sensing Rx |
| cancellation (full- | Cancellation of sensing Tx signal from cellular Rx |
| duplex capability) | |
| SIC | SIC capability for simultaneous reception of cellular |
| | and sensing signals |
| Waveform | Supported types of sensing waveform |

In one example, the UE can indicate the UE's baseband coordination capability between cellular and sensing modems. Possible indication of values could include {tight coordination, loose coordination, no coordination} as an example. Tight coordination may indicate that the cellular baseband has a full control over sensing baseband or sensing capability is implemented as a function of cellular baseband within an integrated chipset. Loose coordination may indicate that the cellular baseband and sensing baseband can communication on related parameters but one does not have a control over the other. No coordination may indicate that the two baseband functions cannot communicate with each other.

In another example, the UE can indicate the UE's sensing power class to the NW. As an example, the UE can indicate that the UE's sensing power class is the same with the UE's power class for communication or a specific power value, e.g., in decibel-milliwatts (dBm), to the NW, if different.

In yet another example, the UE can indicate the UE's supported sensing bandwidth, e.g., in mega-Hertz (MHz) or giga-Hertz (GHz), so that the NW does not configure a UE for sensing bandwidth exceeding the UE's capability. The UE can also indicate the list of bands that the UE supports for sensing operation. It can be indicated, for instance, in terms of NR band identifier (ID). The UE can also indicate whether in-band sensing can be supported, i.e., operation within a band configured for communication. If in-band sensing is not supported, then by default, the NW can assume that only out-of-band sensing can be supported by the UE.

In yet another example, the UE can indicate whether RF/antennas are shared or separate between cellular and sensing functions. The UE can also indicate whether RF/antennas are shared or separate between sensing transmission and reception. Based on this information, the NW can configure a correct mode of sensing operation, e.g., monostatic or bi-static, and resources for the UE.

In yet another example, the UE can indicate whether the UE has self-interference cancellation capability, e.g., cancellation of cellular transmission signal from sensing reception signal or cancellation of sensing transmission signal from cellular reception signal, etc. The UE can also indicate successive interference cancellation capability between a signal received for communication and a signal received for sensing. The UE can also indicate supported types of sensing waveforms as a part of UE capability indication.

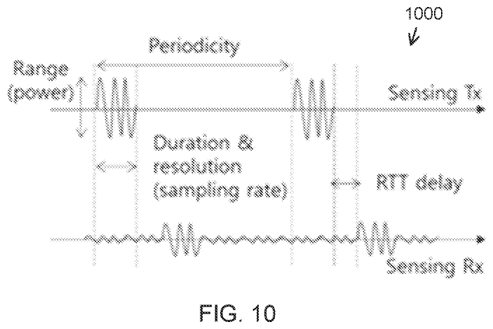

FIG. 10 illustrates an example timing diagram for monostatic sensing according to various embodiments of this disclosure. The embodiment of FIG. 10 is for illustration only. Other embodiments of the timing 1000 could be used without departing from the scope of this disclosure.

FIG. 10 is an example sensing timing diagram for monostatic sensing, i.e., transmission of sensing waveform and the reception of reflected signal occur one at a time due to shared RF/antennas. In this case, the sensing transmission signal duration T_{sensing Tx} should be less than or equal to T_{RTT}−T_{T_Turnaround}, where T_{RTT} is the expected round-trip-time for sensing transmission signal bounce-back considering target sensing application and range and T_{Turnaround} is sensing RF transmission-to-reception turnaround time. If bi-static sensing is supported by UE, no such restriction is required.

In one embodiment, UE sends sensing configuration request message including sensing application type, range, and sensing periodicity, etc. Table. 2 is an example list of possible IEs for UE sensing configuration request message to NW:

TABLE 2
Possible IE for UE sensing configuration request msg

| | |
|---|---|
| Application type | Automotive, face/gesture recognition, etc. |
| Range | Target sensing range, e.g., short/mid/long range sensing |
| Periodicity | Continuous or periodic sensing w/ interval |
| Resolution | Required resolution |
| Directional | Beam sweeping for directional sensing, number of |
| sensing | beams, antenna/beamforming gain, 3-dB beam width |
| Sensing direction | Time duration of sensing Tx signal and reception |
| | duration |

In one example, the UE can indicate the UE's sensing application type, such as automotive, face/gesture recognition, etc., as the sensing resource configuration by NW may depend on the requested sensing application type. In another embodiment, the sensing application type may not be directly indicated to the NW but may be indirectly indicated via attributes of required sensing resource configuration.

In another example, the UE can indicate the desired range of sensing operation. As an example, long range sensing may be requested for automotive application or similarly short range sensing may be requested for face/gesture recognition application. The requested range values can be {short, mid, long} with predefined range values for each element. The requested range values can be in terms of meters. The configured sensing transmission power level by NW may depend on this indication.

In yet another example, the UE can indicate the desired periodicity of the sensing, i.e., continuous or periodic sensing with a certain interval. The configured time-domain sensing resource by NW may depend on this indication.

In yet another example, the UE can indicate the desired resolution of the sensing, i.e., fine granularity for sensing. The configured sensing bandwidth by NW may depend on this indication.

In yet another example, the UE can indicate whether directional sensing is requested. In this case, the UE can indicate the desired beamforming gain, 3 decibel (dB) beam width, and the number of beams for sweeping. The UE can obtain object sensing results towards certain directions which can enable various use cases requiring directional sensing information.

In yet another example, the UE can indicate time duration of sensing transmission signal and reception duration. In the case of bi-static sensing, the transmission and reception can be continuous. In the case of monostatic sensing, the transmission duration can be dependent on sensing application type and/or target sensing range, etc.

In another embodiment, the UE can indicate an index from a set of predefined sensing modes (e.g., TABLE 3 below). Each mode is associated with attributes that can support a certain use case including transmission power, bandwidth, range, periodicity, resolution, directional sensing, sensing duration, etc.

TABLE 3
Example of predefined sensing mode

| Mode | Tx Power | BW | (Intended use case) |
|---|---|---|---|
| 1 | 20 dBm | 10 MHz | Automotive |
| 2 | −1 dBm | 100 MHz | Face recognition |
| 3 | 0 dBm | 40 MHz | Gesture recognition |
| 4 | 10 dBm | 20 MHz | Indoor presence detection |
| . . . | . . . | . . . | . . . |

In one embodiment, the NW configures a UE with sensing resources and attributes and the UE performs sensing according to the configuration. TABLE 4 is an example list of possible IEs for NW sensing configuration message:

TABLE 4
Possible IE for NW sensing configuration msg

| | |
|---|---|
| Max Tx power | Max sensing Tx power, i.e., PCMAX |
| Target reception | For sensing Tx power control based on the pathloss |
| power | of the bounced back sensing Tx signal |
| Waveform | Sensing Tx waveform |
| Periodicity | Sensing periodicity interval |
| Sensing duration | Sensing Tx time duration and Rx time duration |
| Directional sensing | Allowed number of beams for sensing sweeping, |
| | allowed beamforming/antenna gain, 3-dB beam |
| | width, etc. |
| Resource | Sensing time/frequency resource configuration |
| | including signal BW and carrier frequency |

The IEs may include maximum transmission power for sensing waveform transmission, target reception power of the reflected sensing waveform for power control, sensing waveform and transmission periodicity, sensing duration, attributes for directional sensing including allowed number of beams and beam width, and sensing resource in time, frequency, and spatial domain, etc.

For illustrative purposes the steps of algorithms above are described serially. However, some of these steps may be performed in parallel to each other. The operation diagrams illustrate example methods that can be implemented in accordance with the principles of the present disclosure and various changes could be made to the methods illustrated in the flowcharts. For example, while shown as a series of steps, various steps in each figure could overlap, occur in parallel, occur in a different order, or occur multiple times. In another example, steps may be omitted or replaced by other steps.

Although this disclosure has been described with an exemplary embodiment, various changes and modifications may be suggested to one skilled in the art. It is intended that this disclosure encompass such changes and modifications as fall within the scope of the appended claims.

What is claimed is:

1. A method performed by a user equipment (UE), the method comprising:
transmitting, to a base station (BS), UE sensing capability information, the UE sensing capability information including coexistence of sensing function with cellular communication function within the UE, UE sensing hardware capability, and capability related to UE sensing parameters or modes;
transmitting, to the BS, a sensing configuration request, the sensing configuration request including sensing application type, sensing range, and sensing periodicity or including an index from a plurality of predefined sensing modes;
receiving, from the BS, a sensing configuration, the sensing configuration including sensing transmission power, power control related parameters, waveform, and sensing resources and periodicity; and
performing, based on the sensing configuration, a sensing procedure.

2. The method of claim 1, wherein the UE sensing capability information comprises one of:
whether the UE is capable of canceling a cellular communication signal transmitted by the UE from a sensing signal received at the UE;
whether the UE is capable of canceling a sensing signal transmitted by the UE from a cellular communication signal received at the UE; and
whether the UE is capable of successive interference cancellation for simultaneous reception of cellular communication and sensing signals.

3. The method of claim 1, wherein the UE sensing capability information comprises one of:
capability to control a sensing function of the UE by a cellular modem within the UE;
whether antennas for cellular communication are shared for sensing;
whether simultaneous operation of sensing and communication is possible;
whether antennas for sensing transmission and sensing reception are shared;
whether monostatic, bistatic, or both monostatic and bistatic sensing are supported; and
supported types of sensing waveforms.

4. The method of claim 1, wherein the UE sensing capability information comprises one of:
a maximum transmission power capability for sensing;
a maximum supported sensing bandwidth;
an indication of whether aggregating multiple carriers for transmitting and receiving sensing signals is supported, and the supported number of carriers for aggregation;
a list of bands supported for sensing including licensed and unlicensed spectrum; and
an indication of whether in-band sensing is supported.

5. The method of claim 1, wherein the sensing configuration request further includes one of:
a desired transmission power or range;
a desired sensing resolution or bandwidth;
whether a continuous or periodic sensing is employed;
whether directional sensing is employed;
a desired number of beams and beam pattern, if directional sensing is employed; and
sensing duration.

6. The method of claim 1, wherein the sensing configuration request comprises one of a plurality of predefined sensing modes, each of the sensing modes associated with one of a transmission power, a bandwidth, range, a periodicity, a resolution, whether directional sensing is used, a sensing duration, or sensing application type.

7. The method of claim 1, wherein the sensing configuration received from the BS further includes a number of beams allowed for sensing sweeping, a beamforming/antenna gain allowed, or a 3 decibels (dB) beam width.

8. The method of claim 1, wherein the sensing configuration received from the BS further includes parameters related to channel access mechanism if unlicensed spectrum is configured, the parameters including listen-before-talk (LBT) type, contention window size, energy and/or signal detection threshold, or allowance of channel occupancy time (COT) sharing.

9. A user equipment (UE), the UE comprising:
a processor; and
a transceiver operably coupled to the processor, the transceiver configured to:
transmit, to a base station (BS), UE sensing capability information, the UE sensing capability information including coexistence of sensing function with cellular communication function within the UE, UE sensing hardware capability, and capability related to UE sensing parameters or modes, and
transmit, to the BS, a sensing configuration request, the sensing configuration request including sensing application type, sensing range, and sensing periodicity or including an index from a plurality of predefined sensing modes, and
receive, from the BS, a sensing configuration, the sensing configuration including sensing transmission power, power control related parameters, waveform, and sensing resources and periodicity,
wherein the UE is configured to perform, based on the sensing configuration, a sensing procedure.

10. The UE of claim 9, wherein the UE sensing capability information comprises one of:
whether the UE is capable of canceling a cellular communication signal transmitted by the UE from a sensing signal received at the UE;
whether the UE is capable of canceling a sensing signal transmitted by the UE from a cellular communication signal received at the UE; and
whether the UE is capable of successive interference cancellation for simultaneous reception of cellular communication and sensing signals.

11. The UE of claim 9, wherein the UE sensing capability information comprises one of:
capability to control a sensing function of the UE by a cellular modem within the UE;
whether antennas for cellular communication are shared for sensing;
whether simultaneous operation of sensing and communication is possible;
whether antennas for sensing transmission and sensing reception are shared;
whether monostatic, bistatic, or both monostatic and bistatic sensing are supported; and
supported types of sensing waveforms.

12. The UE of claim 9, wherein the UE sensing capability information comprises one of:
a maximum transmission power capability for sensing;
a maximum supported sensing bandwidth;
an indication of whether aggregating multiple carriers for transmitting and receiving sensing signals is supported, and the supported number of carriers for aggregation;
a list of bands supported for sensing including licensed and unlicensed spectrum; and
an indication of whether in-band sensing is supported.

13. The UE of claim 9, wherein the sensing configuration request further includes one of:
a desired transmission power or range;
a desired sensing resolution or bandwidth;
whether a continuous or periodic sensing is employed; whether directional sensing is employed;
a desired number of beams and beam pattern, if directional sensing is employed; and
sensing duration.

14. The UE of claim 9, wherein the sensing configuration request comprises one of a plurality of predefined sensing modes, each of the sensing modes associated with one of a transmission power, a bandwidth, range, a periodicity, a resolution, whether directional sensing is used, a sensing duration, or sensing application type.

15. The UE of claim 9, wherein the sensing configuration received from the BS further includes a number of beams allowed for sensing sweeping, a beamforming/antenna gain allowed, or a 3 decibels (dB) beam width.

16. The UE of claim 9, wherein the sensing configuration received from the BS further includes parameters related to channel access mechanism if unlicensed spectrum is configured, the parameters including listen-before-talk (LBT) type, contention window size, energy and/or signal detection threshold, or allowance of channel occupancy time (COT) sharing.

17. A base station, comprising:
a processor; and
a transceiver operably coupled to the processor, the transceiver configured to:
receive, from a user equipment (UE), UE sensing capability information, the UE sensing capability information including coexistence of sensing function with cellular communication function within the UE, UE sensing hardware capability, and capability related to UE sensing parameters or modes, and
receive, from the UE, a sensing configuration request, the sensing configuration request including sensing application type, sensing range, and sensing periodicity or including an index from a plurality of predefined sensing modes, and
transmit, to the UE, a sensing configuration, the sensing configuration including sensing transmission power, power control related parameters, waveform, and sensing resources and periodicity.

18. The base station of claim 17, wherein the UE sensing capability information comprises:
whether the UE is capable of canceling a cellular communication signal transmitted by the UE from a sensing signal received at the UE;
whether the UE is capable of canceling a sensing signal transmitted by the UE from a cellular communication signal received at the UE; and
whether the UE is capable of successive interference cancellation for simultaneous reception of cellular communication and sensing signals.

19. The base station of claim 17, wherein the UE sensing capability information comprises:
capability to control a sensing function of the UE by a cellular modem within the UE;
whether antennas for cellular communication are shared for sensing;
whether simultaneous operation of sensing and communication is possible;
whether antennas for sensing transmission and sensing reception are shared;
whether monostatic, bistatic, or both monostatic and bistatic sensing are supported; and
supported types of sensing waveforms.

20. The base station of claim 17, wherein the UE sensing capability information comprises:
a maximum transmission power capability for sensing;
a maximum supported sensing bandwidth;
an indication of whether aggregating multiple carriers for transmitting and receiving sensing signals is supported, and the supported number of carriers for aggregation;
a list of bands supported for sensing including licensed and unlicensed spectrum; and
an indication of whether in-band sensing is supported.
